(19) United States
(12) Patent Application Publication
(10) Pub. No.: US 2025/0332804 A1
(43) Pub. Date: Oct. 30, 2025

(54) BUFFER FORMING METHOD AND BUFFER

(71) Applicant: Jui-Chun CHANG, Sugar Land, TX (US)

(72) Inventor: Jui-Chun CHANG, Sugar Land, TX (US)

(21) Appl. No.: 19/189,773

(22) Filed: Apr. 25, 2025

Related U.S. Application Data
(60) Provisional application No. 63/639,288, filed on Apr. 26, 2024.

(51) Int. Cl. B31D 3/02

(52) U.S. Cl. CPC B31D 3/0207

(57) ABSTRACT

A buffer forming method includes the step of providing a honeycomb core that includes a plurality of sheet materials. Each of the sheet materials is formed with two dash-slitted lines. For each of the sheet materials, the dash-slitted lines divide the sheet material into a top deform portion, a bottom deform portion, and an intermediate portion. The buffer forming method further includes the steps of inserting the honeycomb core into a buffer forming machine, conveying the honeycomb core in a stretching direction using an expansion unit of the buffer forming machine to expand the honeycomb core, and compressing the sheet materials in order to respectively fold the top deform portions and the bottom deform portions along the dash-slitted lines to shape the honeycomb core into a buffer.

### CROSS-REFERENCE TO RELATED APPLICATION

This application claims the benefit of U.S. Provisional Patent Application No. 63/639288, filed on Apr. 26, 2024, the entire disclosure of which is incorporated by reference herein.

### FIELD

The disclosure relates to a packaging material, and more particularly to a buffer forming method and a buffer.

### BACKGROUND

A buffer is disposed in a box to act as a cushion for items contained in the box; in other words, the buffer prevents the items from being damaged by impact during shipping. In recent years, the logistics industry has been rapidly developing, and logistics-related industries, such as manufacture of the buffering packaging materials, have also been prospering.

Currently, two types of conventional buffers are commonly used: inflatable plastic buffers, and honeycomb core buffers. Since environmental issues are becoming more prominent, buffers with reduced plastic are bound to be the focus for future development.

In recent years, since paper is more suitable for environmental needs in terms of degradation and decomposition, conventional buffers made of paper are widely used.

U.S. Pat. No. 6,871,480 discloses a packaging wrap that includes a folded layer disposed between two flat sheet materials that can be continuously unfurled. A top portion and a bottom portion of the folded layer each have a plurality of end edges that are adhered to the flat sheet materials.

U.S. Pat. No. 9,649,823 discloses a packaging material that includes a core portion and at least one liner. The core portion has a plurality of walls. The walls form three-dimensional geometric patterned structures. The three-dimensional geometric patterned structures define air spaces and reinforce structural strength of the packaging material. It can be noted from the disclosures of the abovementioned prior art that, even

though expandable buffers are widely used in packaging gradually, the conventional buffers still do not deviate from the corrugated paper form, which is formed by bonding flat sheet materials to folded parts.

Essentially, in a completely formed conventional buffer, a solid part of the conventional buffer only takes up 5-20% of the total volume, and the remaining volume is expansion space. Therefore, the conventional buffer causes significant hurdles and high cost in shipping; moreover, in comparison to plastic buffers, buffers made of paper further have the problem of high manufacturing cost, which is disadvantageous to the development thereof.

A conventional buffer forming approach includes the following steps: (1) folding an expansion portion to form a folded portion, and (2) bonding at least one flat sheet material to the folded portion to secure the folds in place. The buffers respectively disclosed in U.S. Pat. Nos. 6,871,480 and 9,649,823 require the folded portions (i.e., the folded layer in U.S. Pat. No. 6,871,480, and the core portion in U.S. Pat. No. 9,649,823) to be secured in place before the buffers are transported, which causes problems in shipping cost. Chinese Invention Patent Application Publication No. 115593796A discloses a

shockproof honeycomb paper pad structure and a manufacturing approach thereof. The manufacturing approach includes the following steps: first expanding shockproof latticed paper pads into hexagonal paper strips, spacing the hexagonal paper strips evenly apart, adhering the hexagonal paper strips together to form shockproof honeycomb paper pads, and in a state where tensile strain remains constant, making the shockproof honeycomb paper pads enter an inverted scraper. After the honeycomb paper pads enter the inverted scraper, both top and bottom ends of the stretched hexagonal paper strips are deformed and bent towards a side. After the deformed shockproof latticed paper pads are transferred to a pair of rollers that has a designed gap to conduct shape rolling, a shockproof honeycomb paper pad that has a designed thickness is formed. At this time, both the top and bottom ends of the hexagonal paper strips form folds at non-adhered areas, and middle portions of adhered areas are bent.

The abovementioned manufacturing approach has some problems. The stretched hexagonal paper strips actually have different stiffness existing in the non-adhered areas and the adhered areas, and folds are formed at both the top and bottom ends of the non-adhered areas through the inverted scrapers. Since each of the adhered areas is formed by adhering two paper strips, stiffness is high, and the stretched hexagonal paper strips are not easy to deform directly through the inverted scrapers. Therefore, the stretched hexagonal paper strips are then subjected to shape rolling through a pair of rollers that has a gap therebetween with a pre-set height.

The pre-set height of the gap is 30-50% of a height of each of the hexagonal paper strips so that the pair of rollers can overcome the stiffness of the adhered areas to shape the hexagonal paper strips during shape rolling. However, this also severely decreases a buffering effect of the shockproof honeycomb paper pad structure. Furthermore, each of the hexagonal paper strips is compressed to 50-65% of an original height thereof for more stable shaping, which causes the middle portions to bend. Bending the middle portions of the hexagonal paper strips is equivalent to deforming the hexagonal paper strips by direct compression, which will overly decrease its buffering effect. Speed and output steadiness for manufacturing the shockproof honeycomb paper pad structure will also be severely affected.

Moreover, since the hexagonal paper strips are bent through significant compression, the bent hexagonal paper strips vary in height, which causes the shockproof honeycomb paper pad structure to have an uneven surface easily.

In conclusion, in the approaches that use honeycomb cores as packaging materials, the approaches having the step of continuous expansion shaping are important. These approaches save high-cost shipping fees, and are advantageous to environmentally friendly reuse. However, how to simultaneously keep the middle of the paper strips from bending as much as possible to maintain a preferred buffering effect, and have a smooth and fast continuous production while the honeycomb cores are shaped and expanded, is a problem that needs to be solved urgently.

### SUMMARY

Therefore, an object of the disclosure is to provide a buffer forming method that can alleviate at least one of the drawbacks of the prior art.

According to the disclosure, the buffer forming method includes the steps of providing a honeycomb core, inserting the honeycomb core into a buffer forming machine, conveying the honeycomb core in a stretching direction using an expansion unit of the buffer forming machine to expand the honeycomb core, and compressing a plurality of sheet materials in order to respectively fold top deform portions and bottom deform portions along dash-slitted lines to shape the honeycomb core into a buffer. The honeycomb core includes the plurality of sheet materials. Each of the plurality of sheet materials is elongated in a widthwise direction, and has a plurality of bonded portions and a plurality of unbonded portions that are alternately arranged in the widthwise direction. For each three adjacent ones of the 15 plurality of sheet materials, the plurality of bonded portions of the middle sheet material are alternately bonded to the plurality of bonded portions of another sheet material and the plurality of bonded portions of the remaining sheet material. Each of the plurality of sheet materials is formed with, before being bonded to another one of the plurality of sheet materials, two of the dash-slitted lines that are respectively located on a top portion and a bottom portion thereof. The dash-slitted lines extend in the widthwise direction such that, for each of the plurality of sheet materials, the dash-slitted lines divide the sheet material into the top deform portion, the bottom deform portion, and the intermediate portion. The plurality of sheet materials have substantially same heights in a height direction perpendicular to the widthwise direction. A sum of a height of the top deform portion in the height direction and a height of the bottom deform portion in the height direction is less than a height of the intermediate portion in the height direction. The height of each of the plurality of sheet materials in the height direction is 1-6 cm. A thickness of each of the plurality of sheet materials 10 is 0.08-0.2 mm.

Another aspect of the disclosure is to provide another buffer forming method that can alleviate at least one of the drawbacks of the prior art.

According to the disclosure, the buffer forming method includes the steps of providing a honeycomb core, inserting the honeycomb core into a buffer forming machine, conveying the honeycomb core in a stretching direction using an expansion unit of the buffer forming machine to expand the honeycomb core, and compressing a plurality of sheet materials in order to respectively fold top deform portions and bottom deform portions along pressed lines to shape the honeycomb core into a buffer. The honeycomb core includes the plurality of sheet materials. Each of the plurality of sheet materials is elongated in a widthwise direction, and has a plurality of bonded portions and a plurality of unbonded portions that are alternately arranged in the widthwise direction. For each three adjacent ones of the plurality of sheet materials, the plurality of bonded portions of the middle sheet material are alternately bonded to the plurality of bonded portions of another sheet material and the plurality of bonded portions of the remaining sheet material. Each of the plurality of sheet materials is formed with, before being bonded to another one of the plurality of sheet materials, two of the pressed lines that are respectively located on a top portion and a bottom portion thereof. The pressed lines extend in the widthwise direction such that, for each of the plurality of sheet materials, the pressed lines divide the sheet material into the top deform portion, the bottom deform portion, and the intermediate portion. The plurality of sheet materials have substantially same heights in a height direction perpendicular to the widthwise direction. A sum of a height of the top deform portion in the height direction and a height of the bottom deform portion in the height direction is less than a height of the intermediate portion in the height direction. The height of each of the plurality of sheet materials in the height direction is 1-6 cm. A thickness of each of the plurality of sheet materials is 0.08-0.2 mm.

Yet another aspect of the disclosure is to provide a buffer that can alleviate at least one of the drawbacks of the prior art.

According to the disclosure, the buffer is made by expanding and shaping a honeycomb core. The honeycomb core includes a plurality of sheet materials. Each of the plurality of sheet materials is elongated in a widthwise direction and has a plurality of bonded portions and a plurality of unbonded portions that are alternately arranged in the widthwise direction. For each three adjacent ones of the plurality of sheet materials, the plurality of bonded portions of the middle sheet material are alternately bonded to the plurality of bonded portions of another sheet material and the plurality of bonded portions of the remaining sheet material. Each junction of two bonded portions of two adjacent ones of the plurality of sheet materials forms a thick surrounding wall. Each of the plurality of sheet materials has a top deform portion, a bottom deform portion, and an intermediate portion. The top deform portion extends through the plurality of bonded portions and the plurality of unbonded portions. The bottom deform portion is spaced apart from the top deform portion, and extends through the plurality of bonded portions and the plurality of unbonded portions. The intermediate portion is disposed between the top deform portion and the bottom deform portion, and extends through the plurality of bonded portions and the plurality of unbonded portions. For every two adjacent ones of the plurality of sheet materials, the thick surrounding walls and the plurality of unbonded portions form a plurality of hexagonal honeycomb bodies. Each of the plurality of hexagonal honeycomb bodies consists of four of the plurality of unbonded portions that have a same size in the widthwise direction and that are configured as four faces of the hexagonal honeycomb body, and two of the thick surrounding walls that have a same size in the widthwise direction and that are configured as another two faces of the hexagonal honeycomb body. For each of the plurality of sheet materials, a sum of a height of the top deform portion in a height direction perpendicular to the widthwise direction and a height of the bottom deform portion in the height direction is less than a height of the intermediate portion in the height direction. Each of the thick surrounding walls has two folded segments that are spaced apart from each other in the height direction and that are formed respectively by folding the top deform portions and the bottom deform portions of the two adjacent ones of the plurality of sheet materials. Each of the plurality of unbonded portions has two folded segments that are spaced apart from each other in the height direction and that are formed by respectively folding the top deform portions and the bottom deform portions. The folded segments of the thick surrounding walls and the plurality of unbonded portions keep the honeycomb core expanded.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary schematic view illustrating a step of shaping a honeycomb core into a buffer of an embodiment of a buffer forming method according to the disclosure.

FIG. 2 is a schematic perspective view illustrating the honeycomb core being expanded in a stretching direction.

FIG. 3 is a fragmentary schematic view, illustrating the buffer.

FIG. 4 is a partially enlarged view of FIG. 3.

FIG. 5 is a sectional view taken along line V-V in FIG. 4.

FIG. 6 is a sectional view taken along line VI-VI in FIG. 4.

FIG. 7 is a schematic perspective view illustrating a variation of the honeycomb core being expanded in a stretching direction.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

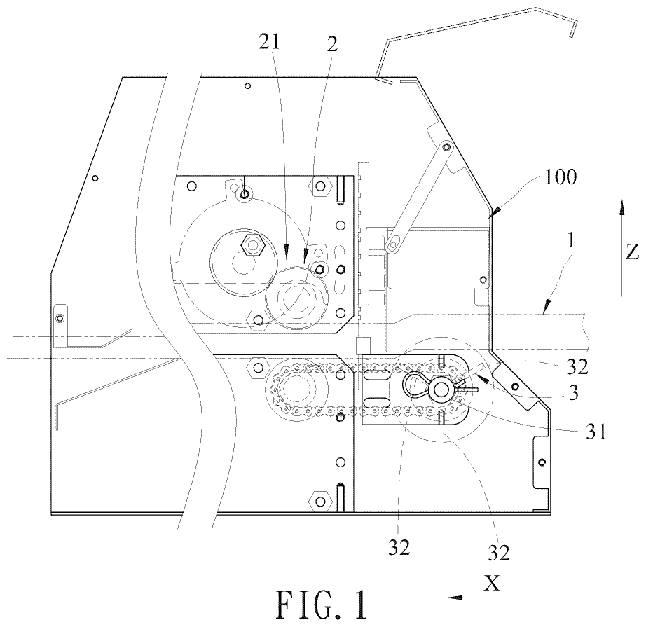

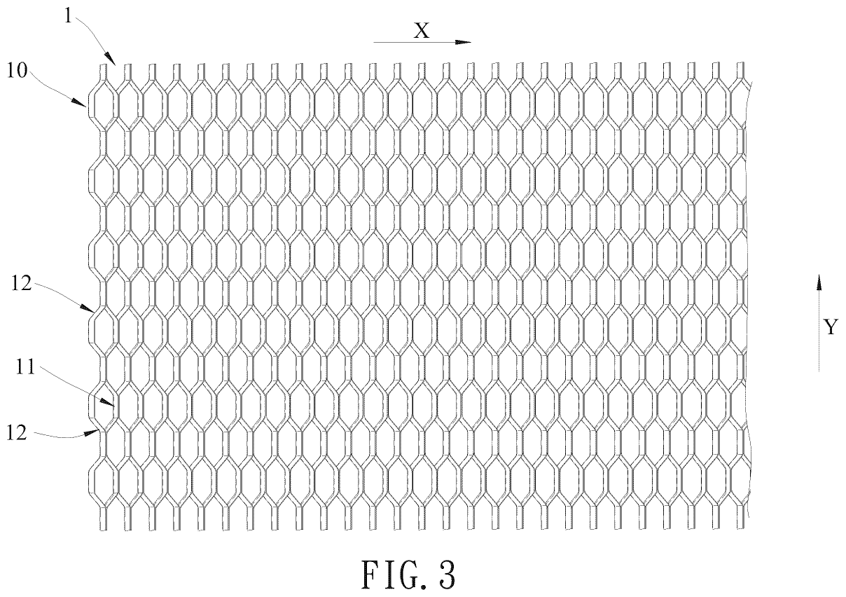

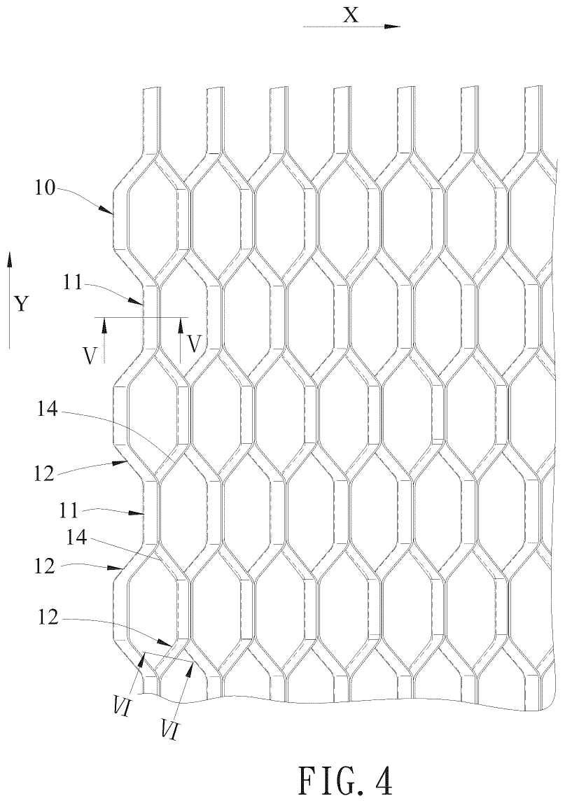

Referring to FIGS. 1 to 4, an embodiment of a buffer forming method according to the disclosure includes the steps of providing a honeycomb core 1, inserting the honeycomb core 1 into a buffer forming machine 100, conveying the honeycomb core 1 in a stretching direction (X) using the buffer forming machine 100 to expand the honeycomb core, and compressing the honeycomb core 1 to shape the honeycomb core 1 into a buffer. The honeycomb core 1 includes a plurality of sheet materials 10. Each of the plurality of sheet materials 10 is elongated in a widthwise direction (Y).

The buffer forming machine 100 has an expansion unit 2 and a feeder unit 3. The honeycomb core 1 is adapted to be drawn by the feeder unit 3 into the expansion unit 2, and then is adapted to be pressed and conveyed in the stretching direction (X) by the expansion unit 2 to expand. The stretching direction (X) is perpendicular to the widthwise direction (Y). When the honeycomb core 1 is conveyed by the expansion unit 2, the sheet materials 10 are folded to shape the honeycomb core 1 into a buffer.

The feeder unit 3 is disposed upstream of the expansion unit 2 in the stretching direction (X), and includes a rotary wheel 31, and a plurality of levers 32 that are mounted to the rotary wheel 31 and that are spaced apart from each other. After two adjacent sheet materials 10 (specifically, the first sheet material 10 of the honeycomb core 1 in the stretching direction (X) and the sheet material 10 adjacent to the first sheet material 10) are pulled apart in the stretching direction (X), and the honeycomb core 1 is hooked onto the levers 32, the feeder unit 3 is activated to drive the rotary wheel 31 and the levers 32 to rotate such that each of the plurality of levers 32 is adapted to be inserted between a corresponding adjacent pair of the plurality of sheet materials 10 to draw the honeycomb core 1 into the expansion unit 2 in the stretching direction (X) for the expansion unit 2 to conduct pressing and conveying of the honeycomb core 1.

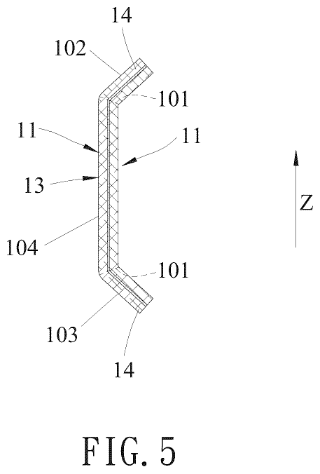

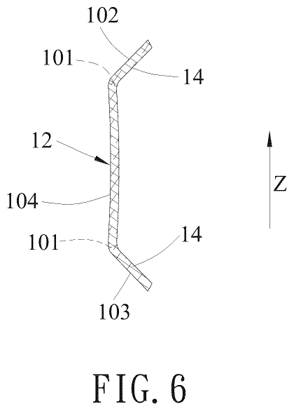

The sheet materials 10 are arranged in the stretching direction (X). Each of the sheet materials 10 has a plurality of bonded portions 11 and a plurality of unbonded portions 12 that are alternately arranged in the widthwise direction (Y). For each three adjacent ones of the plurality of sheet materials 10, the plurality of bonded portions 11 of the middle sheet material 10 are alternately bonded to the plurality of bonded portions 11 of another sheet material 10 and the plurality of bonded portions 11 of the remaining sheet material 10. Each junction of two bonded portions 11 of two adjacent ones of the plurality of sheet materials 10 forms a thick surrounding wall 13. The sheet materials 10 have substantially same heights in a height direction (Z) perpendicular to the widthwise direction (Y) and the stretching direction (X). For every two adjacent ones of the plurality of sheet materials 10, the thick surrounding walls 13 and the unbonded portions 12 form a plurality of hexagonal honeycomb bodies. Each of the plurality of hexagonal honeycomb bodies consists of four unbonded portions 12 that have the same size in the widthwise direction (Y) and that are configured as four faces of the hexagonal honeycomb body, and two thick surrounding walls 13 that have the same size in the widthwise direction (Y) and that are configured as another two faces of the hexagonal honeycomb body. In this embodiment, each two bonded portions 11 of two adjacent ones of the sheet materials 10 are bonded by glue or an adhesive. In other embodiments, the bonded portions 11 may be bonded together through stapling. Each of the plurality of sheet materials 10 is formed with, before being bonded to another one of the plurality of sheet materials 10, two dash-slitted lines 101 that are respectively located on a top portion and a bottom portion thereof. In a variation of the buffer forming method, the dash-slitted lines 101 of each of the plurality of sheet materials 10 are replaced by two pressed lines. The dash-slitted lines 101 extend in the widthwise direction (Y) such that, for each of the plurality of sheet materials 10, the dash-slitted lines 101 divide the sheet material 10 into a top deform portion 102, a bottom deform portion 103, and an intermediate portion 104. A height of the top deform portion 102 in the height direction (Z) and a height of the bottom deform portion 103 in the height direction (Z) are substantially the same. A sum of the height of the top deform portion 102 and the height of the bottom deform portion 103 is 10-50% of a height of the intermediate portion 104 in the height direction (Z). In this embodiment, the sum of the height of the top deform portion 102 and the height of the bottom deform portion 103 is 15-30% of the height of the intermediate portion 104. Referring further to FIG. 5, for each of the sheet materials 10, the top deform portion 102 extends through the bonded portions 11 and the unbonded portions 12, the bottom deform portion 103 is spaced apart from the top deform portion 102 and extends through the bonded portions 11 and the unbonded portions 12, and the intermediate portion 104 is disposed between the top deform portion 102 and the bottom deform portion 103 and extends through the bonded portions 11 and the unbonded portions 12. Each of the thick surrounding walls 13 has two folded segments 14 that are spaced apart from each other in the height direction (Z) and that are formed respectively by folding the top deform portions 102 and the bottom deform portions 103 of the two adjacent ones of the plurality of sheet materials 10. Referring to FIG. 6, each of the unbonded portions 12 has two folded segments 14 that are spaced apart from each other in the height direction (Z) and that are formed by respectively folding the top deform portions 102 and the bottom deform portions 103. The folded segments 14 of the thick surrounding walls 13 and the unbonded portions 12 keep the honeycomb core 1 expanded.

The sheet materials 10 are made of an environmentally friendly material like a recyclable fiber, or a biodegradable material. In some embodiments, the sheet materials 10 are made of recycled paper that has a grammage of 80-200 g/m². Each of the sheet materials 10 has a thickness of 0.08-0.2 mm. A length of each of the sheet materials 10 in the widthwise direction (Y) is 10-80 cm, and a height of each of the sheet materials 10 in the height direction (Z) is 1-6 cm. A length of each of the unbonded portions 12 in the widthwise direction (Y) is 0.5-5 cm. In this embodiment, the sheet materials 10 are made of recycled paper that has a grammage of 120 g/m², and each has a thickness of 0.12 mm. In this embodiment, the length of each of the sheet materials 10 in the widthwise direction (Y) is 30 cm, the length of each of the sheet materials 10 in the height direction (Z) is 2 cm, the length of each of the unbonded portions 12 in the widthwise direction (Y) is 2 cm, and a length of each of the bonded portions 11 in the widthwise direction (Y) is 0.9 cm.

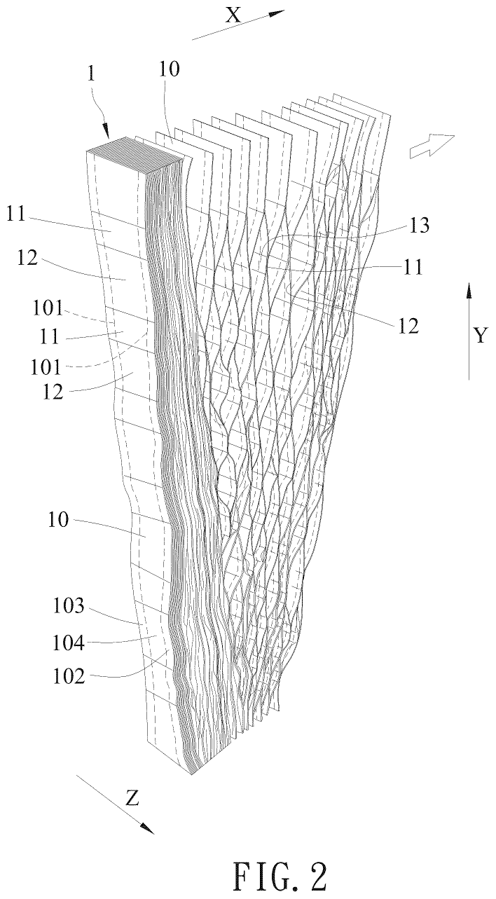

Referring to FIG. 2, the dash-slitted lines 101 includes a plurality of slit portions. A process of manufacturing the sheet materials 10 is as follows. A sheet material roll is continuously unfurled and conveyed, and when the sheet material roll is being unfurled, two dashed line cutters (e.g., cutting tools with spaced cutting edges) cut through the sheet material roll to form the slit portions. Then, the sheet material roll is cut into the plurality of sheet materials 10. It should be noted that, in other embodiments, the slit portions may have other shapes, as long as there is a sufficient distance between two adjacent slit portions. In this embodiment, the dash-slitted lines 101 each are a long dashed line. Each slit portion has a length of 0.2 mm in the widthwise direction (Y), and a distance between two adjacent slit portions is 0.2 mm.

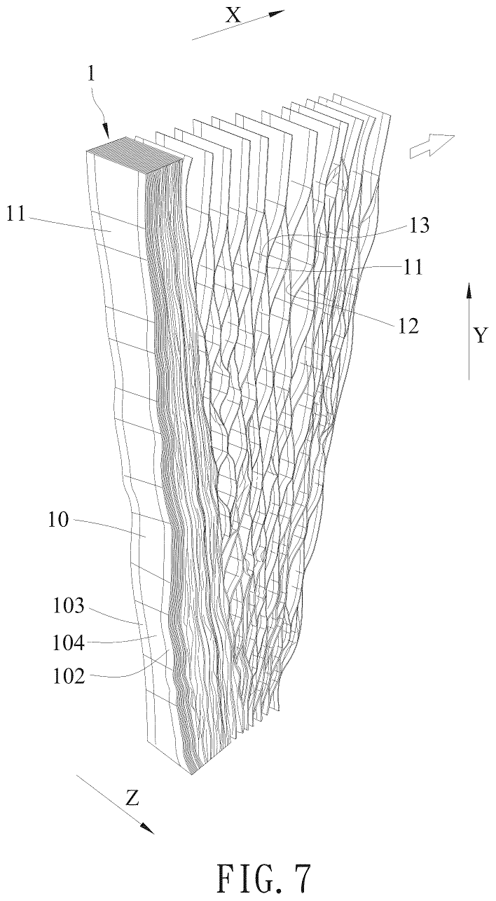

Referring to FIG. 7, in the variation of the embodiment, when the sheet material roll is being unfurled, the pressed lines are formed onto the sheet material roll by rollers. Then, the sheet material roll is cut into the plurality of sheet materials 10. In the variation of the embodiment, for each of the sheet materials 10, the pressed lines divide the sheet material 10 into the top deform portion 102, the bottom deform portion 103, and the intermediate portion 104. The two folded segments 14 of each of the thick surrounding walls 13 are formed by folding respectively the top deform portions 102 and the bottom deform portions 103 of the two adjacent ones of the sheet materials 10 along the pressed lines of the two adjacent ones of the sheet materials 10. The two folded segments 14 of each of the unbonded portions 12 are formed by folding respectively the top deform portions 102 and the bottom deform portions 103 of the two adjacent ones of the sheet materials 10 along the pressed lines of the two adjacent ones of the sheet materials 10. For each of the sheet materials 10, in comparison to the intermediate portion 104, the pressed lines have less stiffness and are easy to deform, so that the buffer forming machine 100 can easily and continuously fold the top deform portions 102 and the bottom deform portions 103 to thereby shape the honeycomb core 1 into a buffer.

The expansion unit 2 includes a friction wheel set 21. The friction wheel set 21 has two friction wheels that define a gap, that are for pressing and conveying the honeycomb core 1, and that are rotatable. In this embodiment, when the friction wheels are rotating after a portion of the honeycomb core 1 is drawn into the expansion unit 2, the remaining portion of the honeycomb core 1 (i.e., the portion of the honeycomb core 1 that has not been drawn into the expansion unit 2) is steadily expanded by gravity. In other embodiments, the remaining portion of the honeycomb core 1 is expanded by applying friction to the honeycomb core 1 to resist movement of the honeycomb core 1 so that the honeycomb core 1 is steadily expanded. When the honeycomb core 1 moves through the gap, the friction wheel set 21 folds the top deform portions 102 and the bottom deform portions 103 to form the folded segments 14 of the thick surrounding walls 13 and the folded segments 14 of the unbonded portions 12. The folded segments 14 of the thick surrounding walls 13 and the unbonded portions 12 keep the honeycomb core 1 expanded.

In other embodiments where the friction wheel set 21 is omitted, the honeycomb core 1 may be shaped with other tools, such as press plates arranged in the height direction (Z).

An embodiment of a buffer according to the disclosure is made by the buffer forming method; in other words, the buffer is made by continuously pressing and conveying a honeycomb core 1 in the stretching direction (X) through the expansion unit 2. The honeycomb core 1 includes a plurality of sheet materials 10. Each of the sheet materials 10 is elongated in the widthwise direction (Y) and has a plurality of bonded portions 11 and a plurality of unbonded portions 12 that are alternately arranged in the widthwise direction (Y). For each three adjacent ones of the sheet materials 10, the bonded portions 11 of the middle sheet material 10 are alternately bonded to the bonded portions 11 of another sheet material 10 and the bonded portions 11 of the remaining sheet material 10. Each junction of two bonded portions 11 of two adjacent ones of the sheet materials 10 forms a thick surrounding wall 13. Each of the sheet materials 10 has a top deform portion 102 that extends through the bonded portions 11 and the unbonded portions 12, a bottom deform portion 103 that is spaced apart from the top deform portion 102 and that extends through the bonded portions 11 and the unbonded portions 12, and an intermediate portion 104 that is disposed between the top deform portion 102 and the bottom deform portion 103 and that extends through the bonded portions 11 and the unbonded portions 12. For every two adjacent ones of the sheet materials 10, the thick surrounding walls 13 and the unbonded portions 12 form a plurality of hexagonal honeycomb bodies. Each of the hexagonal honeycomb bodies consists of four unbonded portions 12 that have the same size in the widthwise direction (Y) and that are configured as four faces of the hexagonal honeycomb body, and two thick surrounding walls 13 that have the same size in the widthwise direction (Y) and that are configured as another two faces of the hexagonal honeycomb body. For each of the sheet materials 10, a height of the top deform portion 102 in the height direction (Z) and a height of the bottom deform portion 103 in the height direction (Z) are substantially the same, and a sum of the height of the top deform portion 102 and the height of the bottom deform portion 103 is 10-50% of a height of the intermediate portion 104 in the height direction (Z). In this embodiment, the sum of the height of the top deform portion 102 and the height of the bottom deform portion 103 is 15-30% of the height of the intermediate portion 104. Each of the thick surrounding walls 13 has two folded segments 14 that are spaced apart from each other in the height direction (Z) and that are formed respectively by folding the top deform portions 102 and the bottom deform portions 103 of the two adjacent ones of the sheet materials 10. Each of the unbonded portions 12 has two folded segments 14 that are spaced apart from each other in the height direction (Z) and that are formed by respectively folding the top deform portions 102 and the bottom deform portions 103. The folded segments 14 of the thick surrounding walls 13 and the unbonded portions 12 keep the honeycomb core 1 expanded.

In conclusion, the buffer forming machine 100 can shape the honeycomb core 1 into a buffer through the buffer forming method of the disclosure, which saves shipping cost. The material of the sheet materials 10 is environmentally friendly and reusable. For each of the sheet materials 10, the heights of the top deform portion 102 and the bottom deform portion 103 are both less than the height of the intermediate portion 104, and less force is needed to bend the top deform portion 102 and the bottom deform portion 103; therefore, the intermediate portion 104 is not bent when the top deform portion 102 and the bottom deform portion 103 are folded, thereby maintaining the buffering effect of the buffer. Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A buffer forming method comprising the steps of:
providing a honeycomb core, the honeycomb core including a plurality of sheet materials, each of the plurality of sheet materials being elongated in a widthwise direction, and having a plurality of bonded portions and a plurality of unbonded portions that are alternately arranged in the widthwise direction, for each three adjacent ones of the plurality of sheet materials, the plurality of bonded portions of the middle sheet material being alternately bonded to the plurality of bonded portions of another sheet material and the plurality of bonded portions of the remaining sheet material, each of the plurality of sheet materials being formed with, before being bonded to another one of the plurality of sheet materials, two dash-slitted lines that are respectively located on a top portion and a bottom portion thereof, and that extend in the widthwise direction such that, for each of the plurality of sheet materials, the dash-slitted lines divide the sheet material into a top deform portion, a bottom deform portion, and an intermediate portion, the plurality of sheet materials having substantially same heights in a height direction perpendicular to the widthwise direction, a sum of a height of the top deform portion in the height direction and a height of the bottom deform portion in the height direction being less than a height of the intermediate portion in the height direction, the height of each of the plurality of sheet materials in the height direction being 1-6 cm, a thickness of each of the plurality of sheet materials being 0.08-0.2 mm; and
inserting the honeycomb core into a buffer forming machine, conveying the honeycomb core in a stretching direction that is perpendicular to the widthwise direction and the height direction using an expansion unit of the buffer forming machine to expand the honeycomb core, and compressing the plurality of sheet materials in order to respectively fold the top deform portions and the bottom deform portions along the dash-slitted lines to shape the honeycomb core into a buffer.

2. The buffer forming method as claimed in claim 1, wherein:
each of the plurality of sheet materials is made of a fiber material that has a grammage of 80-200 g/m², a length of each of the plurality of sheet materials in the widthwise direction being 10 cm-80 cm;
each junction of two bonded portions of two adjacent ones of the plurality of sheet materials forms a thick surrounding wall;
for every two adjacent ones of the plurality of sheet materials, the thick surrounding walls and the plurality of unbonded portions form a plurality of hexagonal honeycomb bodies; and
each of the plurality of hexagonal honeycomb bodies consists of four of the plurality of unbonded portions that have a same size in the widthwise direction and that are configured as four faces of the hexagonal honeycomb body, and two of the thick surrounding walls that have a same size in the widthwise direction and that are configured as another two faces of the hexagonal honeycomb body; and
for each of the sheet materials, the height of the top deform portion in the height direction and the height of the bottom deform portion in the height direction are substantially same, the sum of the height of the top deform portion in the height direction and the height of the bottom deform portion in the height direction being 10-50% of the height of the intermediate portion in the height direction.

3. A buffer forming method comprising the steps of:
providing a honeycomb core, the honeycomb core including a plurality of sheet materials, each of the plurality of sheet materials being elongated in a widthwise direction, and having a plurality of bonded portions and a plurality of unbonded portions that are alternately arranged in the widthwise direction, for each three adjacent ones of the plurality of sheet materials, the plurality of bonded portions of the middle sheet material being alternately bonded to the plurality of bonded portions of another sheet material and the plurality of bonded portions of the remaining sheet material, each of the plurality of sheet materials being formed with, before being bonded to another one of the plurality of sheet materials, two pressed lines that are respectively located on a top portion and a bottom portion thereof, and that extend in the widthwise direction such that, for each of the plurality of sheet materials, the pressed lines divide the sheet material into a top deform portion, a bottom deform portion, and an intermediate portion, the plurality of sheet materials having substantially same heights in a height direction perpendicular to the widthwise direction, a sum of a height of the top deform portion in the height direction and a height of the bottom deform portion in the height direction being less than a height of the intermediate portion in the height direction, the height of each of the plurality of sheet materials in the height direction being 1-6 cm, a thickness of each of the plurality of sheet materials being 0.08-0.2 mm; and
inserting the honeycomb core into a buffer forming machine, conveying the honeycomb core in a stretching direction that is perpendicular to the widthwise direction and the height direction using an expansion unit of the buffer forming machine to expand the honeycomb core, and compressing the plurality of sheet materials in order to respectively fold the top deform portions and the bottom deform portions along the pressed lines to shape the honeycomb core into a buffer.

4. The buffer forming method as claimed in claim 3, wherein:
each of the plurality of sheet materials is made of a fiber material that has a grammage of 80-200 g/m², a length of each of the plurality of sheet materials in the widthwise direction being 10 cm-80 cm;
each junction of two bonded portions of two adjacent ones of the plurality of sheet materials forms a thick surrounding wall;
for every two adjacent ones of the plurality of sheet materials, the thick surrounding walls and the plurality of unbonded portions form a plurality of hexagonal honeycomb bodies; and
each of the plurality of hexagonal honeycomb bodies consists of four of the plurality of unbonded portions that have a same size in the widthwise direction and that are configured as four faces of the hexagonal honeycomb body, and two of the thick surrounding walls that have a same size in the widthwise direction and that are configured as another two faces of the hexagonal honeycomb body; and
for each of the sheet materials, the height of the top deform portion in the height direction and the height of the bottom deform portion in the height direction are substantially same, the sum of the height of the top deform portion in the height direction and the height of the bottom deform portion in the height direction being 10-50% of the height of the intermediate portion in the height direction.

5. A buffer that is made by expanding and shaping a honeycomb core, wherein:
said honeycomb core includes a plurality of sheet materials, each of said plurality of sheet materials being elongated in a widthwise direction and having a plurality of bonded portions and a plurality of unbonded portions that are alternately arranged in the widthwise direction, for each three adjacent ones of said plurality of sheet materials, said plurality of bonded portions of the middle sheet material being alternately bonded to said plurality of bonded portions of another sheet material and said plurality of bonded portions of the remaining sheet material, each junction of two bonded portions of two adjacent ones of said plurality of sheet materials forming a thick surrounding wall;
each of said plurality of sheet materials has a top deform portion that extends through said plurality of bonded portions and said plurality of unbonded portions, a bottom deform portion that is spaced apart from said top deform portion and that extends through said plurality of bonded portions and said plurality of unbonded portions, and an intermediate portion that is disposed between said top deform portion and said bottom deform portion and that extends through said plurality of bonded portions and said plurality of unbonded portions;
for every two adjacent ones of said plurality of sheet materials, said thick surrounding walls and said plurality of unbonded portions form a plurality of hexagonal honeycomb bodies;
each of said plurality of hexagonal honeycomb bodies consists of four of said plurality of unbonded portions that have a same size in the widthwise direction and that are configured as four faces of said hexagonal honeycomb body, and two of said thick surrounding walls that have a same size in the widthwise direction and that are configured as another two faces of said hexagonal honeycomb body;
for each of said plurality of sheet materials, a sum of a height of said top deform portion in a height direction perpendicular to the widthwise direction and a height of said bottom deform portion in the height direction is less than a height of said intermediate portion in the height direction;
each of said thick surrounding walls has two folded segments that are spaced apart from each other in the height direction and that are formed respectively by folding said top deform portions and said bottom deform portions of said two adjacent ones of said plurality of sheet materials; and
each of said plurality of unbonded portions has two folded segments that are spaced apart from each other in the height direction and that are formed by respectively folding said top deform portions and said bottom deform portions, said folded segments of said thick surrounding walls and said plurality of unbonded portions keeping said honeycomb core expanded.

6. The buffer as claimed in claim 5, wherein:
each of said plurality of sheet materials is made of a fiber material that has a grammage of 80-200 g/m², and has a thickness of 0.08-0.2 mm, a length of each of said plurality of sheet materials in the widthwise direction being 10 cm-80 cm, a height of each of said plurality of sheet materials in the height direction being 1-6 cm, a length of each of said plurality of unbonded portions in the widthwise direction being 0.5-5 cm; and
for each of said plurality of sheet materials, the height of said top deform portion in the height direction and the height of said bottom deform portion in the height direction are substantially same, the sum of the height of said top deform portion in the height direction and the height of said bottom deform portion in the height direction being 10-50% of the height of said intermediate portion in the height direction.

7. The buffer as claimed in claim 6, wherein:
each of the plurality of sheet materials includes two dash-slitted lines that are respectively formed on a top portion and a bottom portion thereof such that, for each of said plurality of sheet materials, said dash-slitted lines divide said sheet material into said top deform portion, said bottom deform portion, and said intermediate portion;
said two folded segments of each of said thick surrounding walls are formed by folding respectively said top deform portions and said bottom deform portions of said two adjacent ones of said plurality of sheet materials along said dash-slitted lines of said two adjacent ones of said plurality of sheet materials; and
said two folded segments of each of said plurality of unbonded portions are formed by folding respectively said top deform portions and said bottom deform portions of said two adjacent ones of said plurality of sheet materials along said dash-slitted lines of said two adjacent ones of said plurality of sheet materials.

8. The buffer as claimed in claim 6, wherein:
each of said plurality of sheet materials includes two pressed lines that are respectively formed on a top portion and a bottom portion thereof such that, for each of said plurality of sheet materials, the pressed lines divide the sheet material into the top deform portion, the bottom deform portion, and the intermediate portion;
said two folded segments of each of said thick surrounding walls are formed by folding respectively said top deform portions and said bottom deform portions of said two adjacent ones of said plurality of sheet materials along said pressed lines of said two adjacent ones of said plurality of sheet materials; and
said two folded segments of each of said plurality of unbonded portions are formed by folding respectively said top deform portions and said bottom deform portions of said two adjacent ones of said plurality of sheet materials along said pressed lines of said two adjacent ones of said plurality of sheet materials.
